(19) United States
(12) Patent Application Publication
(10) Pub. No.: US 2014/0174319 A1
(43) Pub. Date: Jun. 26, 2014

(54) FRICTION MATERIAL

(71) Applicants: Kazuhide Yamamoto, Sakai (JP); Yasuki Hattori, Gunma-ken (JP)

(72) Inventors: Kazuhide Yamamoto, Sakai (JP); Yasuki Hattori, Gunma-ken (JP)

(73) Assignee: Nisshinbo Brake, Inc., Tokyo (JP)

(21) Appl. No.: 14/006,672

(22) PCT Filed: Mar. 14, 2012
(86) PCT No.: PCT/JP2012/001760

§ 371 Date: Feb. 3, 2014

(30) Foreign Application Priority Data
Mar. 22, 2011 (JP) 2011-062285

(51) Int. Cl. F16D 69/02

(52) U.S. Cl. CPC F16D 69/02
USPC 106/36

(57) ABSTRACT

The present invention relates to the friction material for the use of disc brake pads and brake shoes for automotive brake devices, and an object of the present invention is to provide the friction material with sufficiently stable braking force and sufficient mechanical strength. In the friction material without a metal or a metal alloy, the friction material includes the plate-like titanate with average particle diameter of 10 to 50 μm and the hydrous magnesium silicate. An amount of the plate-like titanate and the hydrous magnesium silicate is 20 to 30 volume percent relative to the total amount of the friction material, and the volume ratio of the plate-like titanate and the hydrous magnesium silicate is 12:1 to 5:1. Also, the average particle diameter of the plate-like titanate is 20 to 40 μm, and the plate-like titanate is preferably potassium hexatitanate.

### TECHNICAL FIELD

The present invention relates to a friction material to be used for such as automotive disc brake pads and brake shoes.

### BACKGROUND ART

Conventionally, a disc brake and a drum brake are utilized as the automotive brake device, and disc brake pads and brake shoes made by fixing the friction material on a base member made of metal such as steel are utilized as a friction member of the brake device.

A friction material can be classified into three types, (1) a semi-metallic friction material including a large amount of steel fiber as a fiber base material, (2) a raw steel friction material including steel fibers in a part of the fiber base material, and (3) a Non-Asbestos-Organic (NAO) friction material including nonferrous metal fibers as a fiber base material. A friction material that causes less brake noise is demand. The friction material that uses NAO friction material has been widely used, where the friction material does not include a ferrous metal fiber such as a steel fiber and a stainless steel fiber but includes a fiber base material such as a nonferrous metal fiber, an organic fiber and an inorganic fiber, a binder such as thermosetting resin, and a friction modifier such as an organic filler, an inorganic filler, an inorganic abrasive, a lubricant and a metal particle.

A nonferrous metal fiber and/or particle such as aluminum, copper, zinc, and tin and a nonferrous metal alloy fiber and/or particle such as bronze and brass have been used as the NAO friction material.

The Japanese provisional patent publication no. 2001-107026 (Patent Document 1) discloses the friction material formed by heat press forming a friction material compositions including 1-10 weight percent of zinc fiber with the length of 1-10 mm relative to the total amount of the friction material compositions and the above-explained friction material compositions. The Japanese provisional patent publication no. 2002-97455 (Patent Document 2) discloses the friction material compositions including 1-20 weight percent of phosphor bronze fiber with the length of 0.5-10 mm relative to the total amount of the friction material compositions and the friction material formed by heat press forming the friction material compositions. The Japanese provisional patent publication no. 2010-285558 (Patent Document 3) discloses the friction material that at least includes a fiber base material, a friction modifier, and a heavy metal material such as a copper and that formulates at least one type of hydroxyapatite and 1-10 volume percent of zeolite.

The friction material that includes these nonferrous metal fiber and/or particle and nonferrous metal alloy fiber and/or particle, when making a frictional engagement with the mating member such as a disc rotor and a brake drum, forms a thin transferred film of nonferrous metal and nonferrous metal alloy on the frictional surface of the mating member. Then, the transferred film and the nonferrous metal and nonferrous metal alloy components existing on the frictional surface of the friction material create an adhesive friction, thereby enabling and creating a braking force.

However, the adhesive friction of the nonferrous metal and nonferrous metal alloy heavily depends on temperature. Therefore, the braking force may be unstable depending upon the temperature range of the friction material. Also, metal catch, that friction dust of the mating member adheres to the friction material, tends to generate, thereby ultimately leading to a scoring problem.

Furthermore, in recent years, due to environmental consciousness, a friction material that does not contain heavy metal material such as copper and lead is becoming more desirable.

On the other hand, regardless of ferrous and nonferrous, the metal and metal alloy fibers have been used as the fiber base material in order to secure a mechanical strength of the friction material, and the problem is that, without the metal and/or metal alloy fibers, sufficient mechanical strength cannot be obtained.

### PATENT LITERATURE

[Patent Document 1] Japanese Provisional Patent Publication No. 2001-107026

[Patent Document 2] Japanese Provisional Patent Publication No. 2002-97455

[Patent Document 3] Japanese Provisional Patent Publication No. 2010-285558

### SUMMARY

The present invention has been made in view of the above-circumstances. The present invention relates to the friction material used for the brake pad and the brake shoe of the automotive brake device, and an object of the present invention is to provide the friction material with sufficiently stable braking force and sufficient mechanical strength.

For the purpose of securing sufficient mechanical strength of the friction material without metal and/or metal alloy fibers, a relatively large amount of plate-like titanate was added as the inorganic filler having stiffening effect. However, when the large amount of plate-like titanate was added, the plate-like titanate transferred film formed on the frictional surface of the mating member excessively becomes thick while making a frictional engagement between the friction material and the mating member, and as a result, the friction coefficient decreases and no sufficient braking force can be obtained.

Normally, in order to adjust an appropriate thickness of the transferred film, the amount of the abrasive materials that grind the transferred film is increased or more stiff abrasive materials are added; however, such a technique tends to increase a chance of generating the braking noise.

The inventors of the present invention considered that a more effective means to adjust the appropriate thickness of the plate-like titanate transferred film is to decrease the strength of the plate-like titanate transferred film rather than arranging the amount and types of the abrasive materials and focused on the decrease of the strength. Then, the inventors combined the plate-like titanate and hydrous magnesium silicate to obtain the combination transferred film of the plate-like titanate and hydrous magnesium silicate that has less strength than the plate-like titanate transferred film and therefore reached the present invention that can control the appropriate thickness of the transferred film without adding more stiff abrasive materials.

The present invention is a friction material that does not include a ferrous metal, a nonferrous metal, and a nonferrous metal alloy, i.e., not including a metal or a metal alloy but includes the plate-like titanate and hydrous magnesium silicate in specific average particle diameter and in a specific percentage content and is based on the following technologies.

(1) A friction material that does not include a metal or a metal alloy, in which the friction material includes the plate-like titanate in the average particle diameter of 10 to 50μm and hydrous magnesium silicate, where an amount of the plate-like titanate and the hydrous magnesium silicate is 20 to 30 volume percent relative to the total amount of the friction material, and the volume ratio of the plate-like titanate and the hydrous magnesium silicate is 12:1 to 5:1.

(2) The friction material of the above (1), in which the average particle diameter of the plate-like titanate is 20 to 40 μm.

(3) The friction material of the above (1) or (2), in which the plate-like titanate is a potassium hexatitanate.

It is an object of the present invention to provide the friction material that has sufficient and stable braking force and sufficient mechanical strength.

### BRIEF DESCRIPTION OF DRAWINGS

FIG. 1 is a view showing one example of the manufacturing process of the disc brake pad utilizing the friction material of the present invention;

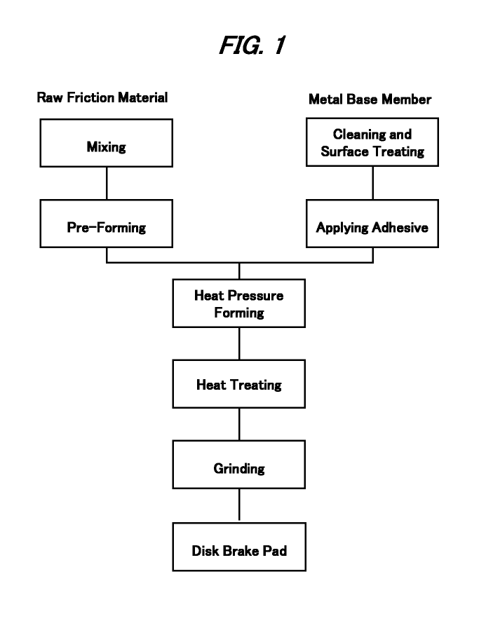

FIG. 2 is a perspective view showing one example of the disc brake pad utilizing the friction material of the present invention;

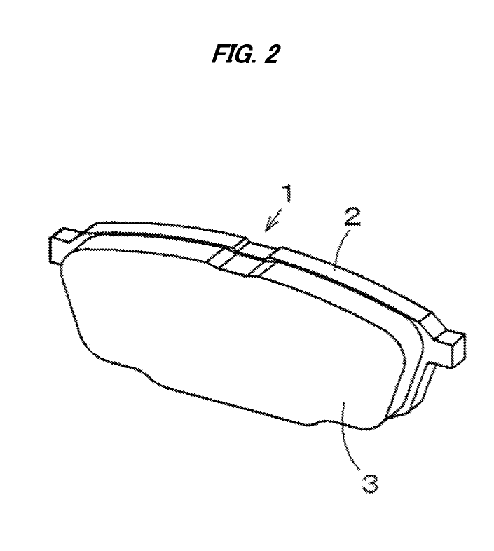

FIG. 3 is a view showing one example of the manufacturing process of the brake shoe utilizing the friction material of the present invention; and

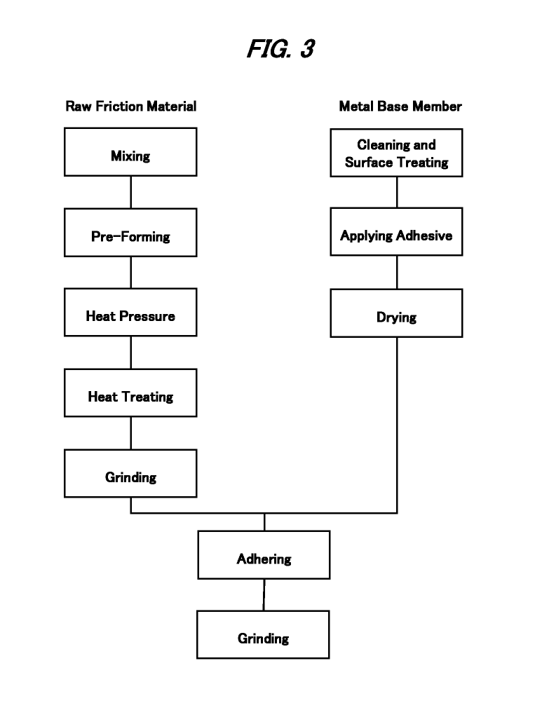

FIG. 4 is a perspective view showing one example of the brake shoe utilizing the friction material of the present invention.

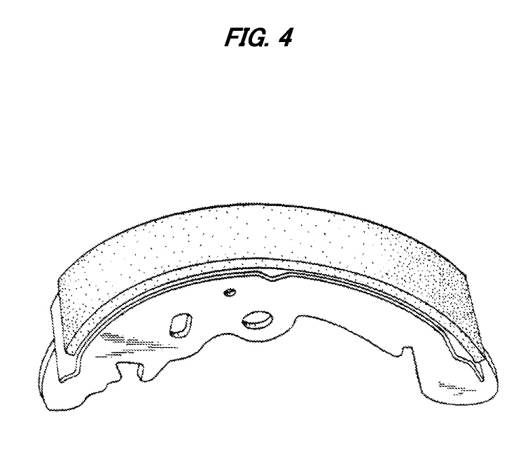

### DESCRIPTION OF EMBODIMENTS

In the present invention, the friction material is arranged so that an amount of the plate-like titanate with average particle diameter of 10 to 50 μm and the hydrous magnesium silicate is designed to be 20 to 30 volume percent relative to the total amount of the friction material and the volume ratio of the plate-like titanate and the hydrous magnesium silicate is designed to be 12:1 to 5:1.

If the prescription of the plate-like titanate and the hydrous magnesium silicate deviates from the above-ranges, (1) the friction material may not obtain sufficient mechanical strength, (2) the wear resistance may be adversely affected, (3) in the case that a strength of the transferred film formed on the frictional surface of the mating member become to large, an excessive thickness of the transferred film is generated, and then the frictional coefficient decreases, in the result, the friction material may not obtain sufficient braking force, and (4) in the case that a strength of the transferred film becomes too little, the transferred film is not generated, and then frictional coefficient decreases, in the result, the friction material may not obtain sufficient braking force.

When the average particle diameter of the above-described plate-like titanate is 20 to 40 μm, the balance between the braking force and the mechanical strength becomes preferable and it is desirable. Also, the plate-like titanate may be such as potassium hexatitanate, potassium octatitanate, lithium potassium titanate, and magnesium potassium titanate, but using potassium hexatitanate with high heat resistance improves the wear resistance and is preferable.

Here, the average particle diameter of the present invention is 50 percent. The particle diameter is measured by a Laser Diffraction-type Particle Size Distribution Measuring Method.

In addition to the above-described plate-like titanate and hydrous magnesium silicate, the friction material of the present invention includes materials that are normally used for the friction material, for example, fiber base materials such as organic fibers and inorganic fibers, binders such as thermosetting resin, and friction modifiers such as organic fillers, inorganic fillers, and lubricants.

The fiber base material may be organic fibers such as aramid fibers and acrylic fibers and inorganic fibers such as carbon fibers, ceramic fibers, and rock wool, and these fibers can be used alone or in combination. The content of the fiber base material, in order to secure the sufficient mechanical strength, is preferably 5 to 60 volume percent relative to the total amount of the friction material and 10 to 50 volume percent relative to the total amount of the friction material is more preferable.

The binder may be the thermosetting resin such as a phenolic resin and epoxy resin, a resin obtained by modifying these thermosetting resins with various elastomers such as cashew oil and silicon oil, and a resin obtained by dispersing the various elastomers and fluorinated polymer on the thermosetting resin. These resins may be used alone or in combination.

The content of the binder, in order to secure the sufficient mechanical strength and wear resistance, is preferably 10 to 30 volume percent relative to the total amount of the friction material and more preferably 12 to 25 volume percent relative to the total amount of the friction material.

The friction modifier may be organic fillers such as cashew dusts, rubber dusts (pulverized rubber powder of tire tread rubber), and various unvulcanized rubber particles and various vulcanized rubber particles, inorganic fillers such as barium sulfate, calcium carbonate, calcium hydroxide, vermiculite, and mica, and lubricants such as molybdenum disulfide, tin sulfide, zinc sulfide, and iron sulfide. These friction modifiers may be used alone or in z The content of the friction modifier should be adjusted according to the desirable frictional characteristics but is preferably 40 to 70 volume percent relative to the total amount of the friction material and is more preferably 50 to 70 volume percent relative to the total amount of the friction material.

The friction material of the present invention is manufactured through a mixing step of stirring the mixture of the predetermined amount of the above-described plate-like titanate, the hydrous magnesium silicate, the fiber base material, the binder, and the friction modifier by a mixer, a heat press forming step of filling the obtained raw friction material mixture into a heat forming die to heat-press-form the same, a heat treatment step of heating the obtained heat product to complete the binder curing, and a grinding step to form the friction surface. As necessary, prior to the heat press forming step, a granulation step of granulating the raw friction material mixture and a pre-forming step of forming a preformed product by filling the raw friction material mixture or granulated raw friction material mixture into a pre-forming die may be conducted, and after the heat press forming step, a coating step, a baking after coating step, and/or a scorching step are conducted.

When manufacturing the disc brake pad, in the heat press forming step, the forming process is performed while superposing the metal back plate such as steel back plate, which is pre-washed, surface treated, and coated with adhesive, with the above-described raw friction material mixture or the granulated product and the preformed product.

### Embodiments

Preferred embodiments and comparative examples of the present invention will be explained in concrete but the present invention is not limited to the following embodiments.

### Manufacturing Method of Friction Material According to Embodiments 1-9 and Comparative Examples 1-7

The frictional material compositions as shown in TABLES 1 and 2 are stirred for 5 minutes using Loedige mixer and the mixture is pressed in the preforming die under 10 MPa for 1 minute. This preformed product is superposed on the steel back plate that is prewashed, surface treated and coated with adhesive, and the preformed product with the back plate is heated at the forming temperature of 150 degrees centigrade and pressurized under the forming pressure of 40 MPa in the heat forming die for 10 minutes. Then, the resultant product is heat treated (post-curing) at 200 degrees centigrade for 5 hours and is grinded to make the automotive disc brake pad (see Embodiments 1-9 and Comparative Examples 1-7). Regarding the mechanical strength, the wear resistance, braking force, and stability of braking force are evaluated. The results of the evaluation can be seen in TABLES 1 and 2.

TABLE 1

| | | Embodiments | | | | | | | | |
|---|---|---|---|---|---|---|---|---|---|---|
| | | 1 | 2 | 3 | 4 | 5 | 6 | 7 | 8 | 9 |
| Fiber Base | Para-aramid Pulp | 13 | 13 | 13 | 13 | 13 | 13 | 13 | 13 | 13 |
| | Copper Fiber | 0 | 0 | 0 | 0 | 0 | 0 | 0 | 0 | 0 |
| Binder | Straight Phenolic Resin | 10 | 10 | 10 | 10 | 10 | 10 | 10 | 10 | 10 |
| | Acrylic Rubber Modified | 10 | 10 | 10 | 10 | 10 | 10 | 10 | 10 | 10 |
| | Phenolic Resin | | | | | | | | | |
| Inorganic | Potassium Hexatitanate | 0 | 0 | 0 | 0 | 0 | 0 | 0 | 0 | 0 |
| Filler | (average particle | | | | | | | | | |
| | diameter of 5 μm) | | | | | | | | | |
| | Potassium Hexatitanate | 24 | 0 | 0 | 0 | 0 | 0 | 0 | 0 | 0 |
| | (average particle | | | | | | | | | |
| | diameter of 10 μm) | | | | | | | | | |
| | Potassium Hexatitanate | 0 | 24 | 24 | 24 | 0 | 0 | 0 | 18 | 27 |
| | (average particle | | | | | | | | | |
| | diameter of 20 μm) | | | | | | | | | |
| | Potassium Hexatitanate | 0 | 0 | 0 | 0 | 24 | 0 | 0 | 0 | 0 |
| | (average particle | | | | | | | | | |
| | diameter of 40 μm) | | | | | | | | | |
| | Potassium Hexatitanate | 0 | 0 | 0 | 0 | 0 | 24 | 0 | 0 | 0 |
| | (average particle | | | | | | | | | |
| | diameter of 50 μm) | | | | | | | | | |
| | Potassium Hexatitanate | 0 | 0 | 0 | 0 | 0 | 0 | 0 | 0 | 0 |
| | (average particle | | | | | | | | | |
| | diameter of 60 μm) | | | | | | | | | |
| | Potassium Octatitanate | 0 | 0 | 0 | 0 | 0 | 0 | 24 | 0 | 0 |
| | (average particle | | | | | | | | | |
| | diameter of 20 μm) | | | | | | | | | |
| | Hydrous magnesium | 3 | 2 | 3 | 4 | 3 | 3 | 3 | 2.5 | 3 |
| | silicate | | | | | | | | | |
| | Zirconium Silicate | 1 | 1 | 1 | 1 | 1 | 1 | 1 | 1 | 1 |
| | Zirconium Oxide | 3 | 3 | 3 | 3 | 3 | 3 | 3 | 3 | 3 |
| | Mica | 3 | 3 | 3 | 3 | 3 | 3 | 3 | 3 | 3 |
| | Magnetite | 3 | 3 | 3 | 3 | 3 | 3 | 3 | 3 | 3 |
| | Cokes | 5 | 5 | 5 | 5 | 5 | 5 | 5 | 5 | 5 |
| | Zinc Sulfide | 2 | 2 | 2 | 2 | 2 | 2 | 2 | 2 | 2 |
| | Calcium Hydroxide | 2 | 2 | 2 | 2 | 2 | 2 | 2 | 2 | 2 |
| | Barium Sulfate | 11 | 12 | 11 | 10 | 11 | 11 | 11 | 17.5 | 8 |
| | Bronze Particles | 0 | 0 | 0 | 0 | 0 | 0 | 0 | 0 | 0 |
| Organic | Rubber Powder of Tire | 3 | 3 | 3 | 3 | 3 | 3 | 3 | 3 | 3 |
| Filler | Tread Rubber | | | | | | | | | |
| | Cashew Dust | 7 | 7 | 7 | 7 | 7 | 7 | 7 | 7 | 7 |
| Total | | 100 | 100 | 100 | 100 | 100 | 100 | 100 | 100 | 100 |
| Evaluation | Wear Resistance | Δ | ∘ | ∘ | ∘ | ∘ | Δ | Δ | Δ | Δ |
| | Braking Force | ∘ | Δ | ∘ | Δ | ∘ | ∘ | ∘ | Δ | Δ |
| | Braking Stability | ∘ | ∘ | ∘ | ∘ | ∘ | ∘ | ∘ | ∘ | ∘ |
| Note | Total of Plate-Like | 27 | 26 | 27 | 28 | 27 | 27 | 27 | 20.5 | 30 |
| | Titanate and Hydrous | | | | | | | | | |
| | magnesium silicate | | | | | | | | | |
| | Volume Ratio of Plate-Like | 8:1 | 12:1 | 8:1 | 6:1 | 8:1 | 8:1 | 8:1 | 7.2:1 | 9:1 |
| | Titanate and Hydrous | | | | | | | | | |
| | magnesium silicate | | | | | | | | | |

TABLE 2

| | | Comparative Examples | | | | | | |
|---|---|---|---|---|---|---|---|---|
| | | 1 | 2 | 3 | 4 | 5 | 6 | 7 |
| Fiber Base | Para-aramid Pulp | 13 | 13 | 13 | 13 | 13 | 13 | 13 |
| | Copper Fiber | 0 | 0 | 0 | 0 | 0 | 0 | 10 |
| Binder | Straight Phenolic Resin | 10 | 10 | 10 | 10 | 10 | 10 | 10 |
| | Acrylic Rubber Modified | 10 | 10 | 10 | 10 | 10 | 10 | 10 |
| | Phenolic Resin | | | | | | | |
| Inorganic | Potassium Hexatitanate | 24 | 0 | 0 | 0 | 0 | 0 | 0 |
| Filler | (average particle | | | | | | | |
| | diameter of 5 μm) | | | | | | | |
| | Potassium Hexatitanate | 0 | 0 | 0 | 0 | 0 | 0 | 0 |
| | (average particle | | | | | | | |
| | diameter of 10 μm) | | | | | | | |
| | Potassium Hexatitanate | 0 | 0 | 24 | 24 | 16 | 28 | 0 |
| | (average particle | | | | | | | |
| | diameter of 20 μm) | | | | | | | |
| | Potassium Hexatitanate | 0 | 0 | 0 | 0 | 0 | 0 | 0 |
| | (average particle | | | | | | | |
| | diameter of 40 μm) | | | | | | | |
| | Potassium Hexatitanate | 0 | 0 | 0 | 0 | 0 | 0 | 0 |
| | (average particle | | | | | | | |
| | diameter of 50 μm) | | | | | | | |
| | Potassium Hexatitanate | 0 | 24 | 0 | 0 | 0 | 0 | 0 |
| | (average particle | | | | | | | |
| | diameter of 60 μm) | | | | | | | |
| | Potassium Octatitanate | 0 | 0 | 0 | 0 | 0 | 0 | 0 |
| | (average particle | | | | | | | |
| | diameter of 20 μm) | | | | | | | |
| | Hydrous magnesium | 3 | 3 | 6 | 1.5 | 2 | 4 | 0 |
| | silicate | | | | | | | |
| | Zirconium Silicate | 1 | 1 | 1 | 1 | 1 | 1 | 1 |
| | Zirconium Oxide | 3 | 3 | 3 | 3 | 3 | 3 | 3 |
| | Mica | 3 | 3 | 3 | 3 | 3 | 3 | 3 |
| | Magnetite | 3 | 3 | 3 | 3 | 3 | 3 | 3 |
| | Coke | 5 | 5 | 5 | 5 | 5 | 5 | 5 |
| | Zinc Sulfide | 2 | 2 | 2 | 2 | 2 | 2 | 2 |
| | CalciumHydroxide | 2 | 2 | 2 | 2 | 2 | 2 | 2 |
| | Barium Sulfate | 11 | 11 | 8 | 12.5 | 20 | 6 | 23 |
| | Bronze Particles | 0 | 0 | 0 | 0 | 0 | 0 | 5 |
| Organic | Rubber Powder of Tire | 3 | 3 | 3 | 3 | 3 | 3 | 3 |
| Filler | Tread Rubber | | | | | | | |
| | Cashew Dust | 7 | 7 | 7 | 7 | 7 | 7 | 7 |
| Total | | 100 | 100 | 100 | 100 | 100 | 100 | 100 |
| Evaluation | Wear Resistance | x | x | ∘ | ∘ | x | x | ∘ |
| | Braking Force | Δ | Δ | x | x | ∘ | ∘ | ∘ |
| | Braking Stability | ∘ | ∘ | ∘ | ∘ | ∘ | ∘ | x |
| Note | Total of Plate-Like | 27 | 27 | 30 | 25.5 | 18 | 32 | — |
| | Titanate and Hydrous | | | | | | | |
| | magnesium silicate | | | | | | | |
| | Volume Ratio of Plate-Like | 8:1 | 8:1 | 4:1 | 16:1 | 8:1 | 7:1 | — |
| | Titanate and Hydrous | | | | | | | |
| | magnesium silicate | | | | | | | |

TABLE 3

| | Evaluating Items | | |
|---|---|---|---|
| | Wear Resistance | Braking Force | Braking Stability |
| Evaluation | In accordance with | In accordance | In accordance with |
| Method | JASO C427 | with JASO C406 | JASO C406 |
| | “Wear Test | “Passenger Car - | “Passenger Car - |
| | Procedure on | Braking Device - | Braking Device - |
| | Inertia | Dynamometer | Dynamometer |
| | Dynamometer - | Test Procedure” | Test Procedure” |
| | Brake Friction | Average | Difference between |
| | Materials” | Frictional | Average Frictional |
| | Initial brake temp.: | Coefficient (μ) of | Coefficient (μ) of |
| | 100 degrees | Second effective | Second effective |
| | centigrade | Test | Test at 50 km/h and |
| | 1000 times of brake | | at 130 km/h |
| | applications | | |
| ◯ | lower than 0.1 mm | 0.40 or higher but | Lower than 0.05 |
| | | lower than 0.45 | |
| Δ | 0.1 mm or higher | 0.36 or higher but | 0.05 or higher but |
| | but lower than | lower than 0.40 | lower than 10 |
| | 0.2 mm | | |
| X | 0.2 mm or higher | Lower than 0.36 | 0.10 or higher |

According to the evaluation results of TABLES 1 and 2, the friction material of the present invention shows sufficiently stable braking force and effective mechanical strength.

### INDUSTRIAL APPLICABILITY

The friction material of the present invention is practically valuable friction material to be used in the disc brake and the drum brake for the automotive brake device and at the same time sufficiently complies with the current needs of the friction material without the heavy metal such as copper and lead.

### REFERENCE NUMBERS

1. disc brake pad
2. back plate
3. friction material
4. brake shoe
5. brake shoe body
6. lining

1. A friction material without a metal or a metal alloy, wherein said friction material includes a plate-like titanate with average particle diameter of 10 to 50 μm and a hydrous magnesium silicate, and wherein an amount of said plate-like titanate and said hydrous magnesium silicate is 20 to 30 volume percent relative to the total amount of the friction material, and
the volume ratio of said plate-like titanate and said hydrous magnesium silicate is 12:1 to 5:1.

2. The friction material of claim 1, wherein the average particle diameter of said plate-like titanate is 20 to 40 μm.

3. The friction material of claim 1, wherein the plate-like titanate is potassium hexatitanate.

4. The friction material of claim 2, wherein the plate-like titanate is potassium hexatitanate.
